(19) United States
(12) Patent Application Publication
(10) Pub. No.: US 2025/0225555 A1
(43) Pub. Date: Jul. 10, 2025

(54) SYSTEMS AND METHODS FOR DIGITAL TAP DISPENSARIES WITH A MOBILE-BASED APPLICATION FOR DETERMING FITNESS-FOR-DUTY

(71) Applicant: Mandrill, Inc., Dover, DE (US)

(72) Inventors: Peter VONK, Pierre, SD (US); Michael PYLE, San Antonio, TX (US); Timothy BREWER, Austin, TX (US); Brandon Robert PETTIT, East Lansing, MI (US)

(73) Assignee: Mandrill, Inc., Dover, DE (US)

(21) Appl. No.: 19/009,197

(22) Filed: Jan. 3, 2025

Related U.S. Application Data
(60) Provisional application No. 63/617,619, filed on Jan. 4, 2024.

(51) Int. Cl. G06Q 30/0601; G06Q 50/26

(52) U.S. Cl. CPC G06Q 30/0607; G06Q 50/26

(57) ABSTRACT

A method and system for automated dispensing of restricted goods based on user verification and a fitness-for-duty determination is provided. The method includes obtaining user feature data via a user device, and performing verification of the user feature data via at least one of a government database or a third-party identity verification database with a digitized representation of a government-issued physical card saved on the user device. The verification is based on a locally occurring cryptographic operation. The method also includes performing analysis of the user feature data with at least one deep learning model for signs of inebriation by determining whether the user is fit-for-duty. The method also includes dispensing automatically, via a digital tap system, the restricted goods upon a positive verification of the user feature data and a result of the analysis with the at least one deep learning model determining that the user is fit-for-duty.

### CROSS-REFERENCE TO RELATED APPLICATIONS

This application claims priority benefit from U.S. Provisional Application No. 63/617,619, filed Jan. 4, 2024, which is hereby incorporated by reference in its entirety.

### FIELD OF THE DISCLOSURE

This technology generally relates to methods and systems for automated dispensing of restricted goods based on a fitness-for-duty determination and a verification of user features, such as age and name or a digitized representation of a government-issued physical card or digital identification with at least one of a government database or a third-party identity verification database, to ensure compliance with the legal requirements regarding the sale of restricted goods.

### BACKGROUND INFORMATION

The sale of restricted goods is tightly governed and regulated by a network of regulations. These regulations stipulate the requirements that must be met before such goods can be sold. For example, in the case of alcohol sales within the United States, the regulations stipulate that the user must be above 21 years old, sales can only be made during certain periods of time, sales to user who are inebriated are prohibited, sales can be performed by licensed vendors, etc. Similarly, as another example, the case of marijuana sales is also heavily regulated, with regulations stipulating age requirements, amount sold, etc. Presently, at the point of sale, staff members (e.g., bartenders, cashiers, etc.) must perform a manual check of the user's identification (e.g., driver's license) to verify the user's identity such as their name and age. This is a time-consuming and tedious process that can be prone to errors and oversights. For instance, during peak sales, the staff members may just perform a cursory check of the user's identification which can lead to errors and oversights. Additionally, the manual check process can incur long wait times for users during peak sales times to purchase these restricted goods.

Accordingly, there is a need for automated dispensing of restricted goods based on verification of user identity features and a fitness-for-duty determination to ensure compliance with the legal requirements regarding the sale of restricted goods and accuracy of verification, as well as minimizing the wait times for the users to purchase and ease of purchase of these restricted goods.

### SUMMARY

The present disclosure, through one or more of its various aspects, embodiments, and/or specific features or sub-components, provides, inter alia, various systems, servers, devices, methods, media, programs, and platforms for an automated dispensing of restricted goods via a digital tap system.

According to an aspect of the present disclosure, a method for automated dispensing of restricted goods based on user verification and a fitness-for-duty determination using a mobile-based application is provided. The method is implemented by at least one processor. The method may include obtaining user feature data via a user device. The method may also include performing verification of the user feature data via at least one of a government database or a third-party identity verification database with a digitized representation of a government-issued physical card saved on the user device, wherein the verification is based on a cryptographic operation occurring locally within the user device.

The method may also include performing analysis of the user feature data with at least one deep learning model for signs of inebriation by determining whether the user is fit-for-duty. The method may also include dispensing automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

The method may further include training the at least one deep learning model to analyze the user feature data to detect the signs of inebriation and updating the at least one deep learning model via backpropagation of errors.

The at least one deep learning model may include an ensemble of deep convolutional neural networks (CNNs).

The digital tap system may include: a product dispenser, at least one sensor, at least one camera, and at least one interface comprising a point-of-sale display operably attached to flow-metered dispensaries for communicating with the user device and with computing devices to manage and operate the digital tap system.

The performing the verification of the user feature data may include verifying the user feature data comprising an age and a name of the user with the digitized representation of the government-issued physical card. The cryptographic operation may occur locally within the user device such that an internet connection to a remote server is not required in the performing the verification.

The digitized representation of the government-issued physical card may be accessible via the user device comprising a mobile device.

The performing the analysis may further include generating a weighted combination measurement based on the obtained user feature data as obtained from at least one sensor; and determining whether the user is fit-for-duty by the at least one deep learning model based on the weighted combination measurement.

According to another aspect of the present disclosure, a digital tap system may be provided for automated dispensing of goods based on user verification and a fitness-for-duty determination. The digital tap system may include: at least one user device, at least one flow-metered dispensary operably attached to at least one sensor and at least one camera, and at least one processor. The digital tap system may also include at least one memory storing instructions for execution by the at least one processor, and at least one communication interface coupled to each of the at least one user device, flow-metered dispensary, processor, and memory.

The at least one processor may be configured to obtain user feature data via the at least one user device. The at least one processor may be configured to perform verification of the user feature data via at least one of a government database or a third-party identity verification database with a digitized representation of a government-issued physical card saved on the at least one user device, wherein the verification is based on a cryptographic operation occurring locally within the at least one user device. The at least one processor may also be configured to perform analysis of the user feature data with at least one deep learning model for signs of inebriation by determining whether the user is fit-for-duty. The at least one processor may also be configured to dispense automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

The at least one processor may be further configured to train the at least one deep learning model to analyze the user feature data to detect the signs of inebriation and update the at least one deep learning model via backpropagation of errors. The at least one deep learning model may include an ensemble of deep CNNs.

The digital tap system may further include a product dispenser, at least one sensor, at least one camera, and at least one interface comprising a point-of-sale display operably attached to flow-metered dispensaries for communicating with the at least one user device and with computing devices to manage and operate the digital tap system.

The at least one processor may be further configured to perform the verification of the user feature data by: verifying the user feature data comprising an age and a name of the user with the digitized representation of the government-issued physical card. The cryptographic operation may occur locally within the at least one user device such that an internet connection to a remote server is not required in the performing the verification.

The digitized representation of the government-issued physical card is accessible via the at least one user device comprising a mobile device.

The at least one processor may be further configured to perform the analysis by generating a weighted combination measurement based on the obtained user feature data as obtained from at least one sensor, and determining whether the user is fit-for-duty by the at least one deep learning model based on the weighted combination measurement.

According to yet another aspect of the present disclosure, a non-transitory computer readable storage medium storing instructions for automated dispensing of goods based on user verification and a fitness-for-duty determination, the storage medium including executable code which, when executed by at least one processor, causes the at least one processor to obtain user feature data via a user device. The at least one processor may be configured to perform verification of the user feature data via at least one of a government database or a third-party identity verification database with a digitized representation of a government-issued physical card saved on the user device, wherein the verification is based on a cryptographic operation occurring locally within the user device. The at least one processor may also be configured to perform analysis of the user feature data with at least one deep learning model for signs of inebriation by determining whether the user is fit-for-duty. The at least one processor may also be configured to dispense automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

The at least one processor may be further configured to train the at least one deep learning model to analyze the user feature data to detect the signs of inebriation and update the at least one deep learning model via backpropagation of errors.

The at least one deep learning model comprises an ensemble of deep CNNs.

The digital tap system may include a product dispenser, at least one sensor, at least one camera, and at least one interface comprising a point-of-sale display operably attached to flow-metered dispensaries for communicating with the user device and with computing devices to manage and operate the digital tap system.

The at least one processor may be further configured to perform the verification of the user feature data by verifying the user feature data comprising an age and a name of the user with the digitized representation of the government-issued physical card. The cryptographic operation may occur locally within the user device such that an internet connection to a remote server is not required in the performing the verification.

The digitized representation of the government-issued physical card is accessible via the user device comprising a mobile device.

The at least one processor may be further configured to perform the analysis by generating a weighted combination measurement based on the obtained user feature data as obtained from at least one sensor, and determining whether the user is fit-for-duty by the at least one deep learning model based on the weighted combination measurement.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary system.

FIG. 2 illustrates an exemplary diagram of a network environment.

FIG. 3 shows an exemplary overview of a digital tap system for implementing a method for automated dispensing of restricted goods based on user verification and a fitness-for-duty determination.

FIG. 4 shows an exemplary system overview of flow-metered dispensaries and user devices.

FIG. 5 shows an exemplary diagram of a network environment between flow-metered dispensaries and user devices.

FIG. 6 shows an exemplary deep learning model and feature data processing for implementing a method for automated dispensing of restricted goods based on user verification and a fitness-for-duty determination according to an embodiment.

FIG. 7 is a flowchart of an exemplary process for implementing a method for automated dispensing of restricted goods based on user verification and a fitness-for-duty determination according to an embodiment.

FIG. 8 shows an exemplary process by a convolutional neural network (CNN) for predicting inebriation according to an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

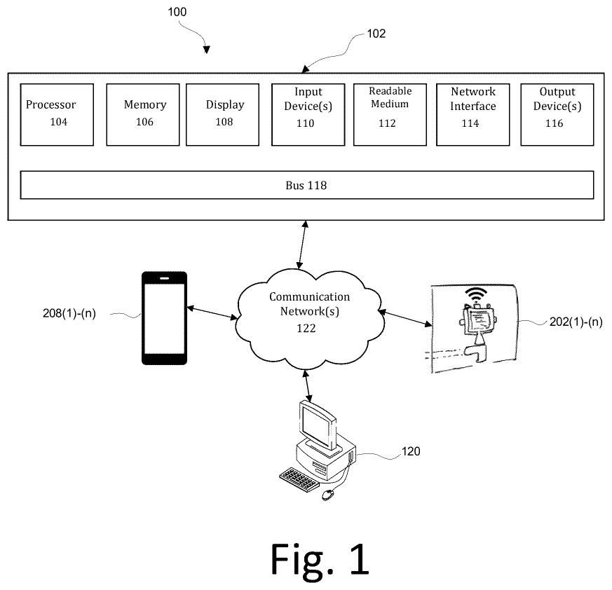

FIG. 1 is an exemplary system for use in accordance with the embodiments described herein. The system 100 is generally shown and may include a computer system 102, user devices 208(1)-(n), and flow-metered dispensaries 202(1)-(n), which are generally indicated.

The computer system 102 may include a set of instructions that can be executed to cause the computer system 102 to perform any one or more of the methods or computer-based functions disclosed herein, either alone or in combination with or be connected to other systems or described devices or peripheral devices, such as the user devices 208(1)-(n) and/or the flow-metered dispensaries 202(1)-(n). The computer system 102 may also operate as a standalone device remotely or externally or may be operably attached to the flow-metered dispensaries 202(1)-(n). For example, the computer system 102 may include, or be included within, any one or more of flow-metered dispensaries 202(1)-(n), computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a user device, a mobile device, a palmtop computer, a laptop computer, a desktop computer, a communications device, a wireless smart phone, a smart device, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time, i.e., software or signals per se. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time, i.e., software or signals per se. The memories are an article of manufacture and/or machine component. Memories described herein are computer-readable mediums from which data and executable instructions can be read by a computer. Memories as described herein may be random access memory (RAM, read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alterative. input devices 110.

The computer system 102 may also include a computer readable medium 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the computer readable medium 112, and/or the processor 104 during execution by the computer system 102. The computer-readable medium 112 is a non-transitory computer-readable medium or media. In a particular non-limiting exemplary embodiment, the computer-readable medium can include a solid-state memory such as a memory card or other package that houses one or more non-volatile read-only memories. Further, the computer-readable medium can be a random-access memory or other volatile re-writable memory.

Additionally, the computer-readable medium can include a magneto-optical or optical medium, such as a disk or tapes or other storage device to capture carrier wave signals such as a signal communicated over a transmission medium. As such, the disclosure is considered to include any computer-readable medium or other equivalents and successor media, in which data or instructions may be stored.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computing devices 120, one or more user devices 208(1)-(n), and/or one or more flow-metered dispensaries 202(1)-(n) via a communication network(s) 122. The computer system 102 can operate remotely or externally as a standalone device from the flow-metered dispensaries 202(1)-(n) or be operably attached to the flow-metered dispensaries 202(1)-(n). The communication network(s) 122 may be, but is not limited to, WiFi®, a local area network, a wide area network, the Internet, a telephony network, a short-range network, or any other network commonly known and understood in the art. The short-range network may include, for example, Bluetooth®, Zigbee®, infrared, near field communication (NFC), ultraband, or any combination thereof. Those skilled in the art appreciate that additional communication network(s) 122 which are known and understood may additionally or alternatively be used and that the communication network(s) 122 are not limited or exhaustive to the examples above. Also, while the communication network(s) 122 is illustrated in FIG. 1 as a wireless network, those skilled in the art appreciate that the communication network(s) 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor or server described herein may be used to support a virtual processing environment.

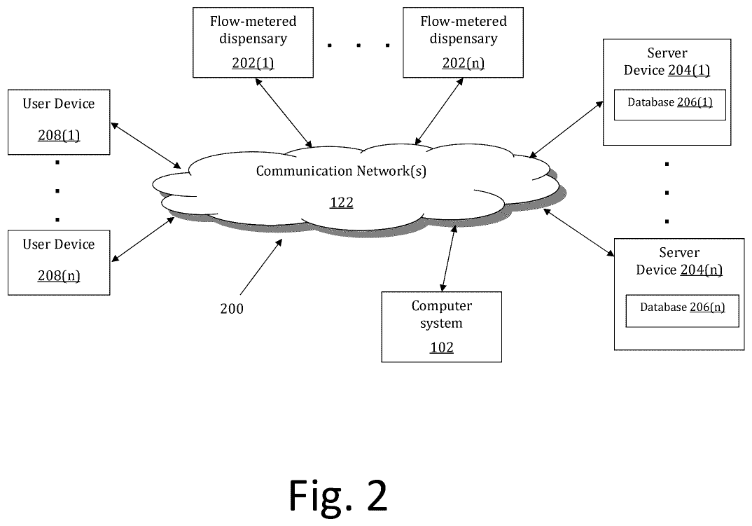

Referring to FIG. 2, a schematic of an exemplary network environment 200 for implementing a method for automated dispensing of restricted goods based on user verification and a fitness-for-duty determination. It is noted that the phrases fitness-for-duty and fit-for-duty may be used interchangeably. In an exemplary embodiment, the method is executable on any networked computer platform, such as, for example, a personal computer (PC).

The method for automated dispensing of restricted goods based on user verification and a fitness-for-duty determination may be implemented by flow-metered dispensaries 202(1)-(n). The computer system 102 may store one or more applications that can include executable instructions that, when executed by the flow-metered dispensaries 202(1)-(n) and/or user devices 208(1)-(n) cause the flow-metered dispensaries 202(1)-(n) and/or user devices 208(1)-(n) to perform actions, such as to transmit, receive, or otherwise process network messages, for example, and to perform other actions described and illustrated below with reference to the figures. For example, the flow-metered dispensaries can perform actions related to starting or ending the dispensing of the restricted goods based on the received executable instructions. In another example, the user devices can perform actions, such as receiving confirmations or denials of a verification of a user's identity from the user's feature data (e.g., age, name, digitized representation of a government-issued physical card or digital identification, etc.), making payments, inputting the user feature data, etc. The application(s) may be implemented as modules or components of other applications. Further, the applications) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment that can provide the executable instructions for the flow-metered dispensaries 202(1)-(n) and/or user devices 208(1)-(n). Also, the application(s) running in a cloud-based computing environment rather than being tied to one or more specific physical network computing devices. Also, the application(s) may be running in one or more virtual machines (VMs).

In the network environment 200 of FIG. 2, flow-metered dispensaries 202(1)-(n) and/or user devices 208(1)-(n) are coupled to a plurality of server devices 204(1)-(n) that hosts a plurality of databases 206(1)-(n), and also to a plurality of user devices 208(1)-(n) via communication network(s) 122. A communication interface of the flow-metered dispensaries 202(1)-(n) operatively couples and communicates between the user devices 208(1)-(n), the server devices 204(1)-(n), and/or the computer system 102, which are all coupled together by the communication network(s) 122, although other types and/or numbers of communication networks or systems with other types and/or numbers of connections and/or configurations to other devices and/or elements may also be used.

The examples may also be implemented on computer systems) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof. Additionally, principles and advantages of distributed processing, such as redundancy and replication also may be implemented, as desired, to increase the robustness and performance of the meters, devices, and systems of the examples.

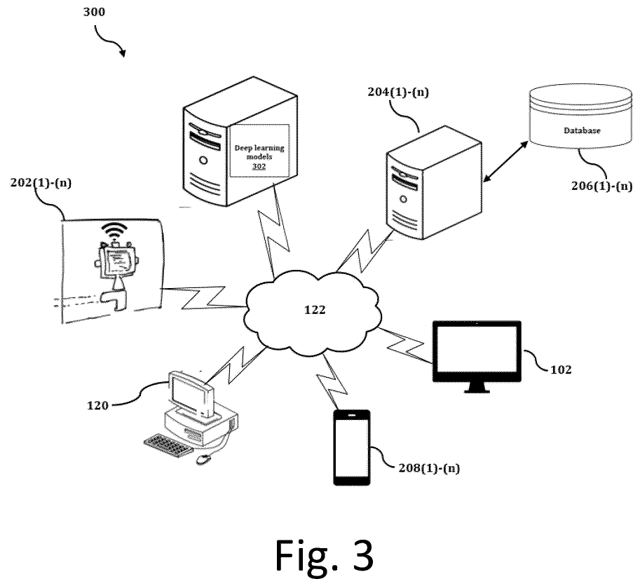

FIG. 3 describes an exemplary overview of a system 300 for implementing a mechanism for automated dispensing of restricted goods based on user verification and a fitness-for-duty determination by using data from the plurality of databases 206(1)-(n) that may comprise a government database, a third-party identity verification database, a deep learning model training data and parameter database, etc. by utilizing the network environment of FIG. 2 that is illustrated as being executed in FIG. 3. Flow-metered dispensaries 202(1)-(n) that act as a digital tap system for dispensing restricted goods is illustrated in the system 300 as being in communication with the user devices 208(1)-(n), deep learning models 302, one or more additional computing devices 120, computer system 102, servers 204(1)-(n). Although the computer system 102 is shown separately in this figure, it can also be operably attached to the flow-metered dispensaries 202(1)-(n).

The user devices 208(1)-(n) can submit a request to purchase the restricted goods through the communication network(s) 122 and input user feature data comprising identification such as a driver's license, state issued identification card, digital passport, etc. The request can be processed by the computer system 102, which can be operably attached to the flow-metered dispensaries 202(1)-(n) or remotely/externally operated, and/or the additional one or more additional computing devices 120 that can perform a verification of the input user feature data by communicate, via the communication network(s) 122, with the plurality of server devices 204(1)-(n) that hosts a plurality of databases 206(1)-(n) that comprise a government database, a third-party identity verification database, etc. containing driver's license data, state issued identification card data, digital passport, etc. Upon a positive verification with the government database or the third-party identity verification database, the computer system 102 and/or the additional one or more additional computing devices 120 can via the communication network(s) 122, notify the user of a positive verification and prompt a user to select the restricted goods for purchase that can also include an amount for purchase. If there is a negative verification, a notification denying the user from purchasing the restricted goods is provided to the user via the user devices 208(1)-(n).

Additionally, prior to prompting a user to select the restricted goods they want to purchase and the amount they want to purchase, the computer system 102 and/or the additional one or more additional computing devices 120 can prompt the user to provide additional user feature data, such as a current image of the user, e.g., a selfie, that can be embodied in a module by the deep learning models 302 to analyze the user feature data for signs of inebriation. Alternatively, the user can be prompted via the user devices 208(1)-(n) regarding the additional user feature data and the flow-metered dispensaries 202(1)-(n) can provide the user feature data (e.g., the current image of the user) using its sensors and/or optical imaging devices (which are described below).

The deep learning models 302 are further described below and comprise deep neural networks such as an ensemble of deep convolutional neural networks (CNNs). Upon receiving the additional user feature data such as the current image of the user, the deep learning models 302 can analyze the additional user feature data for signs of inebriation and generate a prediction result of the analysis of the user feature data (e.g., predicting whether or not the user is inebriated). The deep learning models 302 can communicate, via the communication network(s) 122, with the plurality of server devices 204(1)-(n) to perform this analysis. Wherein the plurality of server devices 204(1)-(n) hosts a plurality of databases 206(1)-(n) that comprises a deep learning model training data and parameter database.

The deep learning models 302 provide the predictive result of the analysis to the flow-metered dispensaries 202(1)-(n) via the computer system 102 and/or the additional one or more additional computing devices 120 via the communication network(s) 122. Based on the predictive result of the analysis, the flow-metered dispensaries 202(1)-(n) via the computer system 102 and/or the additional one or more additional computing devices 120 can, via the communication network(s) 122, notify the user via the user devices 208(1)-(n) of the analysis result and prompt a user to select the restricted goods for purchase that can also include an amount for purchase if the analysis result is that user is not inebriated or deny the user from purchasing the restricted goods if the analysis result is that user is inebriated. That is, the flow-metered dispensaries 202(1)-(n) that acts as a digital tap system can place limits or caps on the restricted goods and the amount of the restricted goods for purchase by the user.

The user can then select the restricted goods (which can also include an amount for purchase) that the user wants to purchase via the user devices 208(1)-(n) and send this selection to the computer system 102 (if the computer system 102 is operating remotely/externally from the flow-metered dispensaries 202(1)-(n)) and/or the additional one or more additional computing devices 120 via the communication network(s) 122, which can then send the selection to the flow-metered dispensaries 202(1)-(n) for dispensing of the restricted goods. If the computer system 102 is operably attached to the flow-metered dispensaries 202(1)-(n)), then the user selection is simply sent, via the communication network(s) 122, straight to the computer system 102 that is operably attached to the flow-metered dispensaries 202(1)-(n)) for dispensing of the restricted goods by the flow-metered dispensaries 202(1)-(n)). That is, an extra sending step from the computer system 102 to the flow-metered dispensaries 202(1)-(n) is not needed since the computer system 102 is operably attached to the flow-metered dispensaries 202(1)-(n)).

The flow-metered dispensaries 202(1)-(n) that act as a digital tap system can be partially or fully automated, wherein a fully automated digital tap system can be used in a variety of venues, including but not limited to: sporting events and stadiums, concerts and events, mobile/temporary deployment events or other locations, bars, cafeterias, markets, food halls, food truck locations, among other potential uses. The characteristics of the flow-metered dispensaries 202(1)-(n) that act as a digital tap system may be modified to meet requirements in various locations and/or to adapt to compliance requirements in specific installed locations.

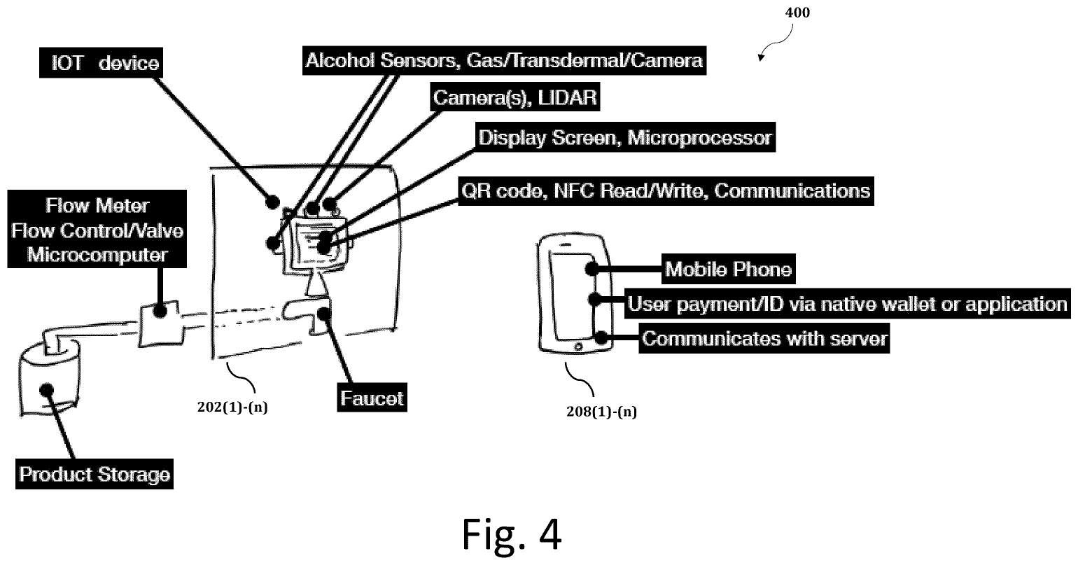

FIG. 4 describes an overview of an exemplary system 400 including flow-metered dispensaries 202(1)-(n) and user devices 208(1)-(n) for implementing a mechanism for automated dispensing of restricted goods based on user verification and a fitness-for-duty determination.

The flow-metered dispensaries 202(1)-(n) are operable as internet-of-thing (IoT) devices or a set of devices and comprise a flow meter, flow control/valve, and/or processor comprising a computer memory (e.g., a microcomputer). Wherein the processor comprising a computer memory is capable of collecting and storing data such as feature data from users (e.g., identification data, image feature data, etc.), type and amount/volume of the restricted goods purchased, as well as other data which may be paired to and used as a dataset for the deep learning models 302 to analyze and generate predictive results of the analysis (e.g., predict signs/level of inebriation).

The flow-metered dispensaries 202(1)-(n) also comprise a product storage for storing the restricted goods (e.g., alcohol, marijuana, tobacco, etc.). The flow-metered dispensaries 202(1)-(n) also comprise a dispersal mechanism (e.g., a faucet) for dispersing/dispensing the restricted goods from the product storage. The flow-metered dispensaries 202(1)-(n) also comprise sensors (e.g., alcohol sensors if the restricted goods are alcohol, touch sensors, optical sensors, gas sensors, temperature sensors, etc.), optical imaging devices (e.g., cameras, gas detection cameras, transdermal cameras, light detection and ranging (LIDAR) cameras, etc.), display screen, and/or microprocessor. The optical imaging devices being capable of measurements across the electromagnetic spectrum, including ultraviolet, visible, infrared and radio spectra. The flow-metered dispensaries 202(1)-(n) are also capable of reading quick response (QR) code, performing near field communication (NFC) read/write operations, and/or providing general communications. The flow-metered dispensaries 202(1)-(n) can be flexibly configured with variations in sensors, optical imaging, etc. as desired.

The user devices 208(1)-(n), although shown as a mobile phone, can be understood to include various user devices, such as but not limited to, a personal computer, a tablet computer, a personal digital assistant, a user device, a palmtop computer, a laptop computer, a communications device, a wireless smart phone, a smart device, a personal trusted device, a wearable device, etc. The user devices 208(1)-(n) can support user payment or identification via a native wallet or application. The user devices 208(1)-(n) can communicate via communications interface with the plurality of server device 204(1)-(n), flow-metered dispensaries 202(1)-(n), and the like. An example of a communications interface may be a communication network(s) 122.

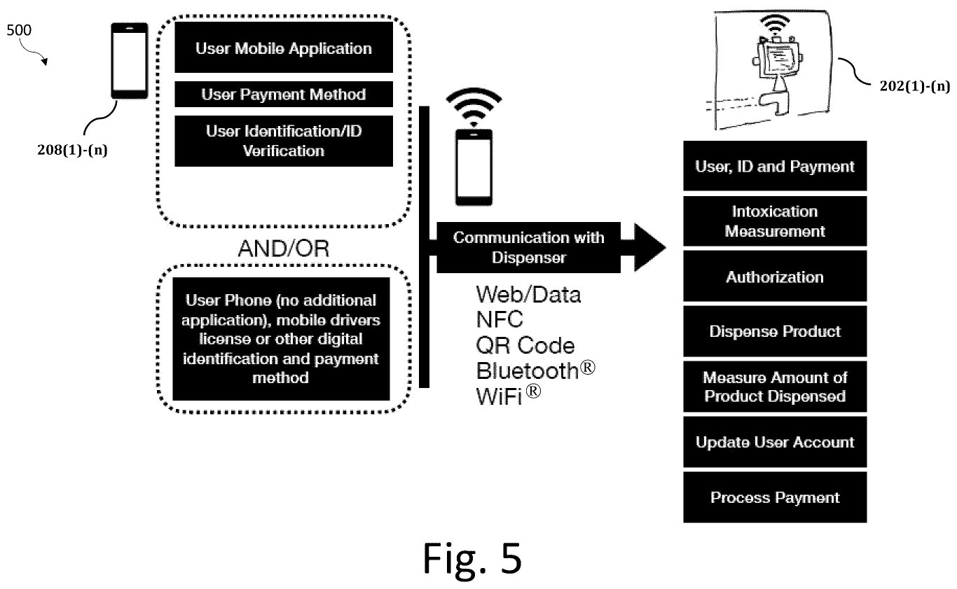

FIG. 5 shows an exemplary diagram 500 of a network environment between flow-metered dispensaries and user devices. User devices 208(1)-(n) can operate a user mobile application that links to the system 300 for digital tapping to enable user identification verification (e.g., driver's license, state issued identification card, digital passport, etc.) and user payment method within the user mobile application, wherein the user would need to provide verification data and payment method within the user mobile application. Alternatively, the user mobile application can instead be allowed access to utilize another mobile application that contains the payment methods data (e.g., native wallet) and identification data within the user devices 208(1)-(n). For example, the user mobile application can seek and be allowed access to utilize existing wireless payment methods (e.g., native wallet) and existing digital identification for verification (e.g., existing applications that already contain the user's identification such as government applications that contain an electronic copy of the user's driver's license, state issued identification card, digital passport, etc.). The user devices 208(1)-(n) can communicate with the flow-metered dispensaries 202(1)-(n) via communication network(s) 122, wherein the communication network(s) was previously defined above. Dispensaries/dispenser being interchangeable.

In an example of sale of restricted goods, e.g., in a non-limiting example wherein the sale of restricted goods involve liquids such as alcohol, the system 300 comprises of flow-metered dispensaries 202(1)-(n), wherein the flow-metered dispensaries 202(1)-(n) may dynamically interact with and control the flow of liquid by controlling a rate of flow of the liquid to the user. The system 300 via the flow-metered dispensaries 202(1)-(n) may change the characteristics of the flow based on the type of liquid being dispensed, current state of the pour, amount of liquid in the user's container, and/or other measured and metered characteristics. The flow-metered dispensaries 202(1)-(n) may also modulate the built-in refrigeration, temperature control, and/or otherwise control the liquid storage conditions.

Although the flow-metered dispensaries 202(1)-(n) has been described as operating with communications comprising internet communications, the flow-metered dispensaries 202(1)-(n) can also operate offline without internet communications if the verification process and payment system functions are similarly able to be performed offline without internet connection.

The system 300 can comprise a single flow-metered dispensary 202(1) or a plurality of flow-metered dispensaries up to an n value (202 (n)) that acts as a digital tap system for dispensing restricted goods. The flow-metered dispensaries 202(1)-(n) may be a standalone dispensaries or installed in a variety of ways depending on the installation location. Wherein the flow-metered dispensaries 202(1)-(n) may include some or all of the sensors as desired.

The flow-metered dispensaries 202(1)-(n) can operate to perform various operations related to the user, such as user verification, payment processing, updating account, authorizing the user account, authorizing the user to make a purchase of restricted goods, etc.

The flow-metered dispensaries 202(1)-(n) may act as a measurement and data aggregation system in more traditional bar environments (e.g., where a bartender is operating the flow-metered dispensaries 202(1)-(n) and verification and payment are performed elsewhere), such as dispensing the restricted goods (i.e., dispensing product), measuring the amount of the restricted goods dispensed (i.e., measure amount of product dispensed, etc.)

The flow-metered dispensaries 202(1)-(n) may also gather metrics for reporting about the restricted goods and/or other information gathered in real-time or statically and display them to the user, staff members (e.g., bartenders, cashiers, etc.), owner, and/or other parties. For example, the flow-metered dispensaries 202(1)-(n) can comprise of a processor such as a microcomputer and sensors that can measure a quantity of the restricted goods being dispensed (e.g., amount of liquids such as alcohol being dispensed), as well as properties of the of the restricted goods being dispensed (e.g., temperature and/or clarity of the liquids such as alcohol being dispensed). The system 300 comprising the flow-metered dispensaries 202(1)-(n) may collect metrics on the performance and status of each of the flow-metered dispensaries 202(1)-(n). Such metrics may include the quantity of the restricted goods sold, time of sale, rate at which the restricted goods are being sold, demographics of users, temperature and storage conditions of the restricted goods being sold, remaining quantity of the restricted goods available for sale, etc. Such metrics can be used to inform logistics, for supply chain management, as part of a product management system/marketing system, and/or inform other business functions.

Additionally, these metrics may facilitate the flow-metered dispensaries 202(1)-(n) across a plurality of locations in any global location in which the flow-metered dispensaries 202(1)-(n) or system 300 are used. The flow-metered dispensaries 202(1)-(n) may also report measurements and metrics that may provide real-time analytics and historical trends. The reported metrics may be used to provide predictive analytics and identify high-performing or low-performing products at specific locations, regions or in the context of demographics of specific locations. For instance, the flow-metered dispensaries 202(1)-(n) can assist with location tracking of the restricted goods if the flow-metered dispensaries 202(1)-(n) are attached to the container of the restricted goods for sale, as well as continuous monitoring and reporting of the restricted goods from production to delivery and dispensation using the flow-metered dispensaries 202(1)-(n) that acts as a digital tap system.

The flow-metered dispensaries 202(1)-(n) may be used to incentivize sellers and direct users through the facilitation of competitions or gamifications and/or provide incentives, discounts, rewards, points, advertisements or otherwise to users. As a collar, the flow-metered dispensaries 202(1)-(n) can also monitor interactions and user feedback, e.g., via voting actions or through other actions that interact with the digital tap (which is aside from the fundamental function of dispensing the restricted goods).

Furthermore, the flow-metered dispensaries 202(1)-(n) may be used to optimize performance. The metrics data can be combined with machine learning or artificial intelligence or deep learning models or any other data analysis technique to provide insights. The flow-metered dispensaries 202(1)-(n) may be used to enforce or inform standards such as cleaning and maintenance of the dispensaries. The flow-metered dispensaries 202(1)-(n) may be used as part of ensuring compliance with international, national, state and local regulations regarding the sale of the restricted goods by ensuring that sales of the restricted goods are approved only if users pass verification.

These metrics may be reported via a display of the flow-metered dispensaries 202(1)-(n) or system 300 or may also be available through a mobile application, web browser, graphical user interface (GUI), and/or any other user interface. That is, the flow-metered dispensaries 202(1)-(n) or system 300 may include or be operably attached to a point-of-sale display interface.

As such, the flow-metered dispensaries 202(1)-(n) may be configured in various manners, e.g., to facilitate payment but not verification; or verification but not payment; or any combination of measurement, verification, payment, control and/or metrics reporting.

While the flow-metered dispensaries 202(1)-(n) that acts as a digital tap system has been described in facilitating the sale of restricted goods (e.g., alcohol, etc.), it can also be used to facilitate the sale of unrestricted goods as well (e.g., water, etc.) that involves verification (e.g., sale of water to company employees in charge of food supply that would involve verifying the employee's identity and authority to make such purchases, etc.).

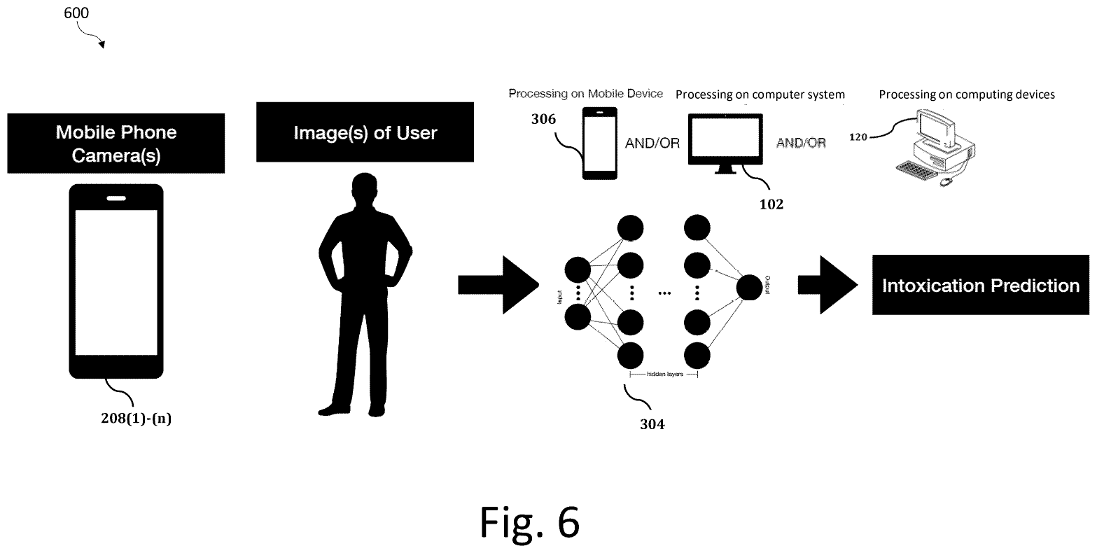

FIG. 6 shows an exemplary deep learning model and feature data processing 600 for implementing a method for automated dispensing of restricted goods based on user verification and a fitness-for-duty determination. User devices 208(1)-(n) can be used to obtain, via an equipped sensor, user feature data comprising identification such as a driver's license, state issued identification card, mobile driver license, digital passport, other digital identification etc., as well as additional user feature data such as a current image of the user, e.g., a selfie. In an example, the equipped sensor may include a camera of the user devices 208(1)-(n) for capturing the user feature data.

Although illustration shows the user devices 208(1)-(n) as a mobile device, it is contemplated as described above that examples of the user devices, can be but are not limited to, a personal computer, a tablet computer, a personal digital assistant, a user device, a mobile device, a palmtop computer, a laptop computer, a communications device, a wireless smart phone, a smart device, a personal trusted device, a wearable device, etc. The various user feature data are input into deep learning models 302.

The at least one deep learning model (which may also be denoted as deep learning models) may comprise deep neural networks, e.g., an ensemble of deep CNNs. A general structure of the at least one deep learning model may be shown at 304, which depicts the various layers of the at least one deep learning model. The various layers may include input layers, hidden layers, and an output layer. Features data of the user (e.g., image(s) of the user, identification information, etc.) may be obtained from the user via e.g., a mobile phone camera(s). These features may then be input into the input layers of the general structure 304 of the at least one deep learning model. Further details are provided subsequently below.

A general structure 304 of at least one deep neural network is depicted, which comprises of input layers, hidden layers, and an output layer. The user feature data is inputted into input layers of the deep neural network and analyzed by the hidden layers, with the predictive result of the analysis being outputted by the output layer. In an example, the hidden layers analyze the various user feature data to predict signs or levels of inebriation, with the predictive result being an indication of whether the user is inebriated or not, i.e., whether the user is intoxicated or not. If so, then the user is denied from purchasing the restricted goods and vice versa.

While the illustration shows just user feature data being inputted, it is also contemplated that the user feature data can be combined with measurements and data taken from other sensors not related to the flow-metered dispensaries 202(1)-(n) (e.g., audio, touch, consumption statistics and/or other data acquired from the user's mobile device, data acquired from state/government sources, history of previous incidents of intoxication such as driving under the influence violations) for processing by the deep learning models in generating the predictive results regarding signs or levels of the user's intoxication or inebriation.

The deep learning models 302 comprising deep neural networks 304 can communicate, via the communication network(s) 122, with the plurality of server devices 204(1)-(n) (not shown in FIG. 6), one or more additional computing devices 120, mobile device 306, and/or computer system 102 to perform this analysis. Wherein the plurality of server devices 204(1)-(n) hosts a plurality of databases 206(1)-(n) that comprises a deep learning model training data and parameter database. That is, the processing can be performed locally or externally. Transmission of the user feature data can be in its original form or a derivative/anonymized form for processing. Additionally, such user feature data can also be collected and utilized by the deep learning models to improve the predictive performance of the deep learning models, e.g., by providing additional training data to the data learning models to improve their predictive performance.

The deep learning models 302 are trained using training data (e.g., images of user being inebriated and not inebriated) to teach the deep learning models 302 the characteristics of the two states of inebriation and no inebriation such that the deep learning models 302 are able to make comparisons between the two states so that the deep learning models 302 can be distinguish between the two states in order to predict whether a user is inebriated or not. The deep learning models 302 are updated using backpropagation of errors until reliable and accurate performance is achieved such that the predictive ability is reliable and accurate. As such, testing and validating data sets are also used to train the deep learning models 302, with updating of the deep learning models 302 via backpropagation until errors are minimized and the performance is reliable and accurate. The trained deep learning models are then used to process, analyze, and make predictions of the user feature data, e.g., real-time user feature data.

The deep learning models 302 comprise deep neural network such as deep CNNs. Wherein the deep CNNs are a type of deep neural networks, with the deep CNNs including additional layers such as pooling layer, convolutional layer, fully connected layer, etc.

These predictive results of whether a user is inebriated or not or predicting levels of such inebriation can be utilized to limit the sale of restricted goods (e.g., alcohol or other intoxicating substances) to the user. Additionally, these predictive results can also be utilized in other applications where verification of non-inebriation/intoxication is useful, such as for determining whether users are fit-for-duty to perform essential job functions or are fit to operate certain vehicles, equipment, construction or heavy machinery or other apparatus, etc. For instance, these predictive results can be integrated into existing driver distraction detection systems in vehicles to prevent operation of the vehicles if the user is inebriated or intoxicated. Furthermore, these predictive results can also be utilized to control access to various sites (e.g., workplaces, bars, restaurants, boarding aircraft, construction sites, etc.) and/or provide an indicator as to whether users are fit-for-duty (e.g., able to perform their essential job functions without posing a danger to themselves or others) based on signs of inebriation or intoxication or levels of inebriation or intoxication. That is, being fit-for-duty may denote that the users can competently perform their essential job functions at a sufficient skill level as necessitated by the job and do so effectively without posing a danger to themselves or others.

The deep learning models 302 that can be embodied in a module can be used as part of the flow-metered dispensaries 202(1)-(n) that act as a digital tap system or as a standalone module to provide inebriation detection to other systems (e.g., in an automobile, marijuana dispensaries, other sale system where regulatory compliance requires making a determination as to the user's state of inebriation or intoxication).

Indeed, these predictive results of whether a user is inebriated or not may include predicted inebriation levels (e.g., high level, moderate level, low level, zero level of inebriation) or predict a blood alcohol content (e.g., 0.08, 0.05, etc.) or provide a binary result (inebriated or not-inebriated). The predictive results with the predicted inebriation level may be utilized to limit the sale of restricted goods (e.g., alcohol or other intoxicating substances) to the user.

Additionally, these predictive results may also be utilized in other applications as well, wherein a verification of non-inebriation/intoxication is useful. An example of such other application may be in determining whether a user is capable of operating vehicles, heavy equipment or equipment needing handling with care, construction machinery or equipment, or other heavy machinery or other apparatus, etc. Indeed, the predictive results may be integrated into existing driver distraction detection systems in a vehicle to prevent the operation of the vehicle if the user is inebriated or intoxicated.

Furthermore, these predictive results may also be utilized to control access to various sites (e.g., workplaces, bars, restaurants, aircrafts, construction sites, etc.) and/or provide an indicator as to whether users are fit-for-duty based on signs of inebriation, signs of intoxication, or levels of inebriation/intoxication. Being fit-for-duty may involve determining whether the user able to perform the user's essential job functions without posing a danger to the user or other people. That is, being fit-for-duty may denote that the users can competently perform their essential job functions at a sufficient skill level as necessitated by the job and do so effectively without posing a danger to themselves or others.

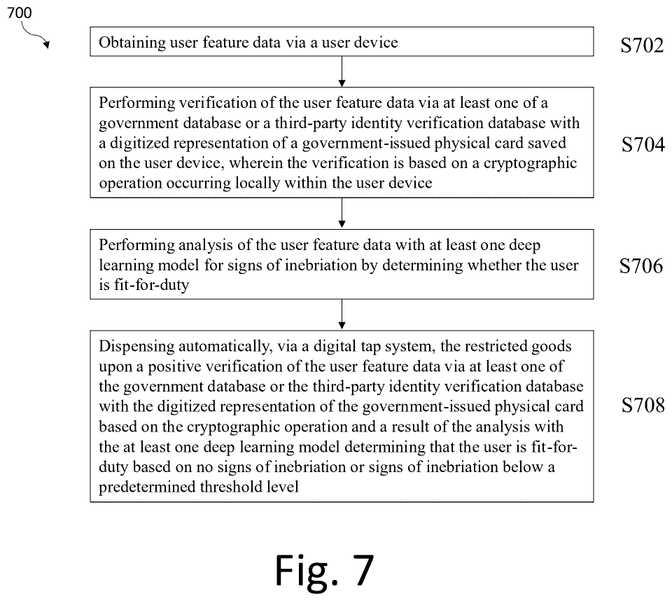

FIG. 7 is a flowchart of an exemplary process 700 for implementing a method for automated dispensing of restricted goods based on user verification and a fitness-for-duty determination using a mobile-based application.

Step S702 describes obtaining user feature data via a user device. User devices 208(1)-(n) can be used to obtain user feature data comprising identification such as a user's name, an age, image, etc. The user devices 208(1)-(n) can be understood to include various user devices, such as but not limited to, a mobile device, a personal computer, a tablet computer, a personal digital assistant, a user device, a palmtop computer, a laptop computer, a communications device, a wireless smart phone, a smart device, a personal trusted device, a wearable device, etc.

Step S704 describes performing verification of the user feature data via at least one of a government database or a third-party identity verification database with a digitized representation of a government-issued physical card saved on the user device, wherein the verification is based on a cryptographic operation occurring locally within the user device. That is, the verification in order to purchase the restricted goods, as well as fitness-for-duty determination may be submitted via a mobile-based application on the user device. A cryptographic operation that occurs locally within the user device may be utilized to perform the verification. This locally occurring cryptographic operation does not require an internet connection to a remote server to perform the verification.

The performing the verification of the user feature data may include verifying the user feature data, such as the age, name, and/or image of the user with the digitized representation of the government-issued physical card. The digitized representation of the government-issued physical card is accessible via the user device comprising a mobile device. Examples of the digitized representation of the government-issued physical card may include, but are not limited to, a driver's license, state issued identification card, digital passport, etc. For instance, the driver's license can be a digitized representation of a driver's license, i.e., a mobile/virtual driver's license.

That is, examples of a digitized representation of a government-issued physical card may include such digital identification or mobile driver's license. Depending on the type of digital identification, an internet connection or remote server might not be needed to perform the verification because a cryptographic operation may be performed locally within the user device by associating or binding the digital identification with another type of identifier, such as a third-party identity verification database, as confirmation of the user's identity with the third-party identity verification database. This third-party identity verification database may be, but is not limited to, a user device like a smartphone with a corresponding PIN, touch ID, or biometric of the user (e.g., fingerprint, heartbeat, facial image, etc.).

In an example, the user's digitized representation of the government-issued physical card may be saved on the user's device and associated or bonded with a corresponding PIN, touch ID, or biometric of the user to serve as confirmation of the user's identity. In this manner, verification can be performed via the cryptographic operation through a comparison and correlation of the user feature data with the digitized representation of the government-issued physical card saved on the user device. This cryptographic operation can occur locally within the user device absent an internet connection.

Alternatively, performing the verification may be verification of the digitized representation of a government-issued physical card with a government database. This may be performed using an internet connection or remote server via a communication network to communicate with the at least one government database. For example, in this alternative scenario, the user devices 208(1)-(n) may submit a request to purchase the restricted goods through the communication network(s) 122 based on the input user feature data comprising identification for verification. The request can be processed by the computer system 102, which can be operably attached to the flow-metered dispensaries 202(1)-(n) or remotely/externally operated, and/or the additional one or more additional computing devices 120 that can perform a verification of the input user feature data by communicating, via the communication network(s) 122, with the plurality of server devices 204(1)-(n) that hosts a plurality of databases 206(1)-(n) that may include a government database or a third-party identity verification database containing driver's license data, state issued identification card data, digital passport, etc. for verification.

The performing the verification of the user feature data in the alternative scenario may also include verifying the user feature data such as an age and a name of the user. Additionally, it may also include verifying a digitized representation of a government-issued physical card or verifying a digital identification with the at least one of the government databases or the third-party identity verification database. The digitized representation may be accessible via the user device or an online system for verifying the digitized representation with the government-issued physical card associated with the digitized representation.

Upon a positive verification with the at least one of the government database or the third-party identity verification database, the user is notified of a positive verification and a prompt can be given to the user to select the restricted goods for purchase that can also include an amount for purchase. If there is a negative verification, a notification denying the user from purchasing the restricted goods is provided to the user via the user devices 208(1)-(n).

Step S706 describes performing analysis of the user feature data with at least one deep learning model for signs of inebriation by determining whether the user is fit-for-duty. The user feature data are transmitted from the user deice 208(1)-(n) for input into the deep learning models 302, wherein the transmission of the user feature data can be in its original form or a derivative/anonymized form for processing. The deep neural networks may be trained to analyze the user feature data to detect the signs of inebriation and updating the at least one deep learning model via backpropagation of errors.

The deep learning models 302 may include deep neural networks, e.g., an ensemble of deep CNNs. That is, the deep learning models 302 may include deep neural network such as deep CNNs. The deep CNNs being a type of deep neural networks, wherein the deep CNNs may include various layers such as input, hidden, output, pooling, convolutional, fully connected, etc. The deep learning models 302 process and analyze the user feature to determine whether the user is inebriated or not inebriated by determining whether the user is fit-for-duty. A predictive result indicating whether the user is inebriated or not, i.e., whether the user is intoxicated or not, is outputted via the output layer.

The performing the analysis may further include generating a weighted combination measurement based on the obtained user feature data as obtained from at least one sensor, and determining whether the user is fit-for-duty by the at least one deep learning model based on the weighted combination measurement.

Step S708 describes dispensing automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level. In an example, the predetermined threshold level can be, e.g., an inebriation or intoxication level as set by the government, such as a blood alcohol content threshold level, if the restricted goods are alcohol, etc.

That is, upon a positive verification and a predictive result from the at least one deep learning model indicating that the user is fit-for-duty and shows no signs of inebriation or signs of inebriation below a predetermined threshold level, then the user is notified via the user devices 208(1)-(n) and prompts can be given to the user notifying the user that the user is fit-for-duty and/or the user can purchase a restricted good. For the sale of the restricted goods, a prompt would be given to the user via the user devices 208(1)-(n) to select the restricted goods for purchase that can also include an amount for purchase. The user can then select the restricted goods (which can also include an amount for purchase) that the user wants to purchase via the user devices 208(1)-(n) and send this selection to the via the communication network(s) 122 to the flow-metered dispensaries 202(1)-(n) for dispensing of the restricted goods.

The digital tap system may have various component including, but not limited to, a product dispenser, at least one sensor, at least one camera, and at least one interface comprising a point-of-sale display operably attached to flow-metered dispensaries for communicating with the user device and with computing devices to manage and operate the digital tap system. The various components may be operably attached to flow-metered dispensaries for communicating with the user device and with computing devices to manage and operate the digital tap system.

Alternatively, if there is a negative verification or the predictive result from the deep learning models 302 indicates that the user is inebriated, the user is also notified via the user devices 208(1)-(n) and can be given notifications via the user devices 208(1)-(n) denying the user from purchasing the restricted goods and stating that the user is not fit-for-duty. Upon an indication that the user is not fit-for-duty, the user can be denied access to various sites (e.g., workplaces, bars, restaurants, aircrafts, construction sites, etc.) and/or be prevented from operating various machinery, vehicles, apparatus, etc. by being locked out of certain vehicles, equipment, construction or heavy machinery or other apparatus, etc. The lock out can be implemented via a lock out operation between the mobile-based application performing the present method and a system/application that controls these various machinery, vehicles, apparatus.

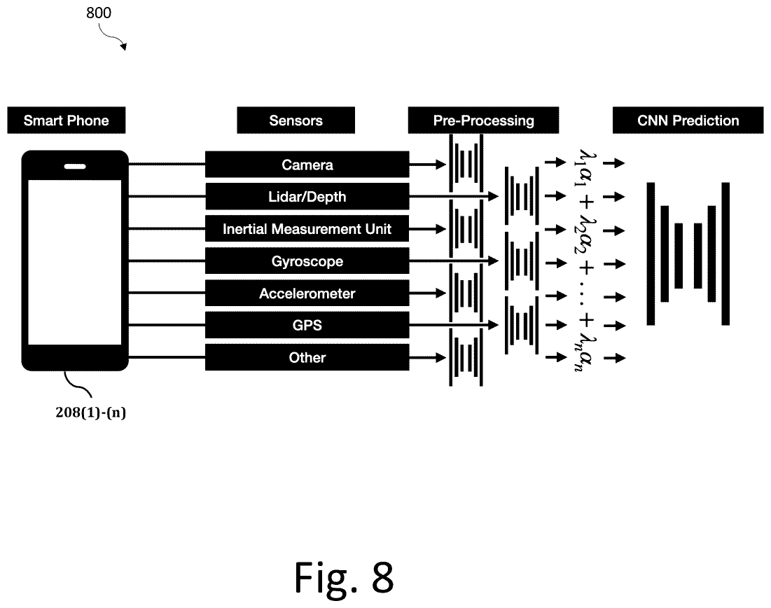

FIG. 8 shows an exemplary process 800 by a CNN for predicting inebriation according to an embodiment. The exemplary process 800 may show user devices 208(1)-(n), which may be a smartphone. The smartphone may include various sensors such as, but not limited to, a camera, LIDAR/depth detection, inertial measurement unit, a gyroscope, an accelerometer, a GPS, and other additional sensors (e.g., audio sensors).

Continuing with the exemplary process 800, the sensors may be used to obtain measurements that are standard on the user devices 208(1)-(n), such as, but not limited to: front or rear-facing cameras, structured light or other depth sensors, inertial measurement units and accelerometers, gyroscopes, GPS, and audio measurements.

The present application may utilize a weighted combination of some or all of these sensors, which may be represented by the following equation:

$${λ}_{1} {α}_{1} + {λ}_{2} {α}_{2} + … + {λ}_{n} {α}_{n}$$

The term λₙ is a floating point weighting factor and an is a measurement from sensor n. The weights as denoted by λₙ may also be applied independently with sensor data processed by individual deep CNN as part of a pre-processing procedure and/or with measurements passed directly to a final deep CNN as part of the ensemble of deep CNNs for sensor fusion and inebriation detection/prediction.

These floating point weighting factors may be designed and adapted to each particular user device. For example, different smartphones, tablets, or other mobile devices may have different sensors available depending on the various different models accordingly, different combinations of sensors available within the various different models. Thus, the resulting measurements may need to be tuned so as to optimize the inebriation detection and prediction performance for each supported device based on the particular device utilized by the user.

The sensor measurements may be captured, pre-processed, and normalized using filtering and other mathematical operations on the individual user device or on a remote computer (e.g., cloud computing) prior to processing with the at least one deep learning model, e.g., the deep CNN.

In addition to the at least one deep learning model, weights and devices that are repeated iterations of model training, input scaling functions, lambda function, etc., may be similarly determined either through fine-tuning operations such as via algorithms as part of the training process.

Furthermore, multiple different deep learning models may be utilized in combination, as may be suitable for different input types. For example, one deep learning model may be utilized to process audio data in combination with a different deep learning model to process image data with red-green-blue (RGB) photo image or video data. Similarly, data from the inertial measurement unit, gyroscope, and/or accelerometer may also be processed using different deep learning models. The outputs of these deep learning models may then be combined as part of a fusion operation, whereby the results of which may then be used to make a prediction/determination of the user's state of inebriation.

In an example, to utilize a self-service beverage dispensing device to make an age-restricted purchase, a user would present an identification and payment information through e.g., a user device (such as a smartphone with a native or companion application) or through e.g., interacting with the kiosk screen, camera and/or other sensors to perform identification verification and provide payment. Upon verification of the user's identification and payment information, an inebriation detection may be performed using either the consumer device and/or a kiosk. If the user has been determined to be in state of not being inebriated, i.e., compliant with governing laws and regulations (e.g., “Dram Shop Laws”), then the user may be permitted to complete the purchase of the age restricted product.

The subject matter in this disclosure has been described with reference to several exemplary embodiments, however, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automated dispensing of restricted goods based on user verification and a fitness-for-duty determination, the method being implemented by at least one processor, the method comprising:
obtaining user feature data via a user device;
performing verification of the user feature data via at least one of a government database or a third-party identity verification database with a digitized representation of a government-issued physical card saved on the user device, wherein the verification is based on a cryptographic operation occurring locally within the user device;
performing analysis of the user feature data with at least one deep learning model for signs of inebriation by determining whether the user is fit-for-duty; and
dispensing automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

2. The method of claim 1, further comprising:
training the at least one deep learning model to analyze the user feature data to detect the signs of inebriation and updating the at least one deep learning model via backpropagation of errors.

3. The method of claim 2, wherein the at least one deep learning model comprises an ensemble of deep convolutional neural networks (CNNs).

4. The method of claim 1, wherein the digital tap system comprises: a product dispenser, at least one sensor, at least one camera, and at least one interface comprising a point-of-sale display operably attached to flow-metered dispensaries for communicating with the user device and with computing devices to manage and operate the digital tap system.

5. The method of claim 1, wherein the performing the verification of the user feature data comprises verifying the user feature data comprising an age and a name of the user with the digitized representation of the government-issued physical card; and
wherein the cryptographic operation occurs locally within the user device such that an internet connection to a remote server is not required in the performing the verification.

6. The method of claim 5, wherein the digitized representation of the government-issued physical card is accessible via the user device comprising a mobile device.

7. The method of claim 1, wherein the performing the analysis further comprises:
generating a weighted combination measurement based on the obtained user feature data as obtained from at least one sensor; and
determining whether the user is fit-for-duty by the at least one deep learning model based on the weighted combination measurement.

8. A digital tap system for automated dispensing of goods based on user verification and a fitness-for-duty determination comprising:
at least one user device;
at least one flow-metered dispensary operably attached to at least one sensor and at least one camera;
at least one processor;
at least one memory storing instructions for execution by the at least one processor; and
at least one communication interface coupled to each of the at least one user device, the at least one flow-metered dispensary, the at least one processor, and the at least one memory, wherein the at least one processor is configured to:
obtain user feature data via the at least one user device;
perform verification of the user feature data via at least one of a government database or a third-party identity verification database with a digitized representation of a government-issued physical card saved on the at least one user device, wherein the verification is based on a cryptographic operation occurring locally within the at least one user device;
perform analysis of the user feature data with at least one deep learning model for signs of inebriation by determining whether the user is fit-for-duty; and
dispense automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

9. The digital tap system of claim 8, wherein the at least one processor is further configured to train the at least one deep learning model to analyze the user feature data to detect the signs of inebriation and update the at least one deep learning model via backpropagation of errors; and
wherein the at least one deep learning model comprises an ensemble of deep convolutional neural networks (CNNs).

10. The digital tap system of claim 8, further comprising: a product dispenser, at least one sensor, at least one camera, and at least one interface comprising a point-of-sale display operably attached to flow-metered dispensaries for communicating with the at least one user device and with computing devices to manage and operate the digital tap system.

11. The digital tap system of claim 8, wherein the at least one processor is further configured to perform the verification of the user feature data by verifying the user feature data comprising an age and a name of the user with the digitized representation of the government-issued physical card; and
wherein the cryptographic operation occurs locally within the at least one user device such that an internet connection to a remote server is not required in the performing the verification.

12. The digital tap system of claim 11, wherein digitized representation of the government-issued physical card is accessible via the at least one user device comprising a mobile device.

13. The digital tap system of claim 8, wherein the at least one processor is further configured to perform the analysis by:
generating a weighted combination measurement based on the obtained user feature data as obtained from at least one sensor; and
determining whether the user is fit-for-duty by the at least one deep learning model based on the weighted combination measurement.

14. A non-transitory computer readable storage medium storing instructions for automated dispensing of goods based on user verification and a fitness-for-duty determination, the storage medium comprising executable code which, when executed by at least one processor, causes the at least one processor to:
obtain user feature data via a user device;
perform verification of the user feature data via at least one of a government database or a third-party identity verification database with a digitized representation of a government-issued physical card saved on the user device, wherein the verification is based on a cryptographic operation occurring locally within the user device;
perform analysis of the user feature data with at least one deep learning model for signs of inebriation by determining whether the user is fit-for-duty; and
dispense automatically, via a digital tap system, the restricted goods upon a positive verification of the user feature data via at least one of the government database or the third-party identity verification database with the digitized representation of the government-issued physical card based on the cryptographic operation and a result of the analysis with the at least one deep learning model determining that the user is fit-for-duty based on no signs of inebriation or signs of inebriation below a predetermined threshold level.

15. The non-transitory computer readable storage medium of claim 14, wherein the at least one processor is further configured to:
train the at least one deep learning model to analyze the user feature data to detect the signs of inebriation and update the at least one deep learning model via backpropagation of errors.

16. The non-transitory computer readable storage medium of claim 15, wherein the at least one deep learning model comprises an ensemble of deep convolutional neural networks (CNNs).

17. The non-transitory computer readable storage medium of claim 14, wherein the digital tap system comprises: a product dispenser, at least one sensor, at least one camera, and at least one interface comprising a point-of-sale display operably attached to flow-metered dispensaries for communicating with the user device and with computing devices to manage and operate the digital tap system.

18. The non-transitory computer readable storage medium of claim 14, wherein the at least one processor is further configured to perform the verification of the user feature data by:
verifying the user feature data comprising an age and a name of the user with the digitized representation of the government-issued physical card; and
wherein the cryptographic operation occurs locally within the user device such that an internet connection to a remote server is not required in the performing the verification.

19. The non-transitory computer readable storage medium of claim 18, wherein the digitized representation of the government-issued physical card is accessible via the user device comprising a mobile device.

20. The non-transitory computer readable storage medium of claim 14, wherein the at least one processor is further configured to perform the analysis by:
generating a weighted combination measurement based on the obtained user feature data as obtained from at least one sensor; and
determining whether the user is fit-for-duty by the at least one deep learning model based on the weighted combination measurement.
